(19) United States
(12) Patent Application Publication
(10) Pub. No.: US 2015/0135045 A1
(43) Pub. Date: May 14, 2015

(54) METHOD AND SYSTEM FOR CREATION AND/OR PUBLICATION OF COLLABORATIVE MULTI-SOURCE MEDIA PRESENTATIONS

(71) Applicant: TUTTI DYNAMICS, INC., New Orleans, LA (US)

(72) Inventors: Darren HOFFMAN, Brooklyn, NY (US); KRISTEN SULLIVAN, New Orleans, LA (US); Adam BELLARD, Brooklyn, NY (US); Jonathan BIGUENET, New Orleans, LA (US); Mike GREENBERG, South Miami, FL (US); Chris READE, New Orleans, LA (US); Ryland JONES, Los Angeles, CA (US); Demetrius WREN, New York, NY (US)

(73) Assignee: TUTTI DYNAMICS, INC., New Orleans, LA (US)

(21) Appl. No.: 14/539,458

(22) Filed: Nov. 12, 2014

Related U.S. Application Data
(60) Provisional application No. 61/903,720, filed on Nov. 13, 2013.

(51) Int. Cl. H04L 12/18

(52) U.S. Cl. CPC H04L 12/1813
USPC 715/202

(57) ABSTRACT

A method implemented in a computer infrastructure having computer executable code tangibly embodied on a computer readable medium, including recording at least one of audio, video, still image, text and other data representations; and creating a multi-source media presentation, including the one or more of the audio, video, still image, text and other data representations

### CROSS REFERENCE TO RELATED APPLICATION

The present application claims the benefit of U.S. Provisional Application No. 61/903,720 filed on Nov. 13, 2013, the disclosure of which is expressly incorporated by reference herein in its entirety.

### FIELD OF THE INVENTION

The present disclosure relates to a method and system for media presentations, and more particularly, to a method and system for creation and/or publication of collaborative, editable, and/or interactive multi-source media presentations (MSMPs).

### BACKGROUND OF THE INVENTION

There are software tools for collaborative music creation, for example, and there are software tools for social creation and sharing of video, audio, text, and other media, but there is a gap between these two tools. Thus, there exists a need for a tool that bridges the gap between these two tools.

### SUMMARY OF EMBODIMENTS OF THE DISCLOSURE

An aim of the embodiments of the disclosure is to provide a method and system for creating, sharing, and/or distributing social, collaborative, interactive MSMPs, for example, for entertainment and/or education purposes, amongst other contemplated purposes. In embodiments, MSMPs for entertainment and/or education purposes may include, for example, musical instruction, dance instruction, fitness instruction, medicine, corporate presentations, interactive advertisements, home security, social networking, or any other type of instruction or multi-media presentation. Aspects of embodiments of the disclosure provide a method and system by which users can record video and audio content, which is synchronized to an existing MSMP. In embodiments, the method and system also allows for users to create a MSMP in a piecemeal fashion, for example, by adding one media asset at a time. Additionally, embodiments of the disclosure provide a method and system for users to share created MSMPs, for example, by way of uploading to remote server storage. Embodiments of the disclosure also provide a method and system for users to download server-stored MSMPs to local storage, for example, for entertainment and/or educational purposes, or for collaborative manipulation, including, e.g., adding to and/or replacing media of the downloaded MSMP. Furthermore, embodiments of the disclosure provide a method and system for compositing video resources into a single paned video that is synchronized to related (or corresponding) audio tracks, still images, text, and/or other media, for example.

Aspects of embodiments of the disclosure are directed to a method implemented in a computer infrastructure having computer executable code tangibly embodied on a computer readable medium. The method comprises recording at least one of audio, video, still image, text and other data representations, and creating a multi-source media presentation, including the one or more of the audio, video, still image, text and other data representations.

In embodiments, the method further comprises replacing media in a multi-source presentation with user generated media.

In embodiments, the method further comprises adding media to a multi-source presentation.

In further embodiments, the method further comprises delivering user generated media to a server for storage.

In additional embodiments, the method further comprises compositing user recorded video into a single composited “paned” video.

In yet further embodiments, the method further comprises delivering the composited “paned” video to a user.

In embodiments, the method further comprises delivering user generated media to other users.

In further embodiments, the method further comprises delivering a multi-source media presentation to users.

In additional embodiments, the method further comprises adding a user generated media file to the multi-source media presentation, including the at least one of audio, video, images, text, and other data.

In yet further embodiments, the method further comprises recording a user generated video, and replacing a single video in a multi-source presentation with the user generated video.

In embodiments, the method further comprises recording of a new user generated audio file and replacement of a single audio file in a multi-source presentation with the user generated audio file.

In further embodiments, the multi-source media presentation comprises at least one of musical instruction, dance instruction, fitness instruction, medicine instruction, a corporate presentation, an interactive advertisement, home security presentation, or a social networking presentation.

In additional embodiments, the method further comprises delivering user-created media to a non-local server for storage.

In yet further embodiments, the method further comprises generating a composite single paned video from multiple source videos.

In embodiments, the method further comprises delivering a composite video to a user.

In further embodiments, the method further comprises delivering user-generated media to another user for the other user's entertainment or for additional creation.

In additional embodiments, the method further comprises the other user adds audio, video, still image, text, or other data representations to the multi-source media presentation.

In yet further embodiments, the method further comprises the other user replacing existing audio, video, still image, text, or other data representations with their own media.

In embodiments, the method further comprises delivering a user-generated multi-source presentation to another user for the other user's entertainment or for additional creation.

In further embodiments, the method further comprises the other user adding audio, video, still image, text, or other data representations to the multi-source media presentation.

In additional embodiments, the method further comprises the other user replacing existing audio, video, still image, text, or other data representations with their own media.

Aspects of embodiments of the disclosure are directed to a system for creation and/or publication of collaborative multi-source media presentations, which is implemented in a computer infrastructure having computer executable code tangibly embodied on a computer readable medium. The system includes a recording tool for recording at least one of audio, video, still image, text and other data representations; and a creation tool configured for creating a multi-source media presentation, including the one or more of the audio, video, still image, text and other data representations.

### BRIEF DESCRIPTION OF THE FIGURES

For a more complete understanding of the disclosure, as well as other objects and further features thereof, reference may be had to the following detailed description of the disclosure in conjunction with the following exemplary and non-limiting drawings wherein:

FIG. 1 shows an exemplary software environment for displaying multi-source media presentations (MSMPs) in accordance with embodiments of the disclosure;

FIG. 2 shows an exemplary method of recording audio and video assets along with a synchronized MSMP in accordance with embodiments of the disclosure;

FIG. 3 shows an exemplary method of creating an MSMP in a piecemeal fashion, adding one media asset at a time in accordance with embodiments of the disclosure;

FIG. 4 shows an exemplary environment for remote storage of MSMP metadata and media content on a server in accordance with aspects of embodiments of the present disclosure;

FIG. 5 shows an exemplary method for delivering MSMPs from a remote server to end users in accordance with embodiments of the disclosure;

FIG. 6 shows an exemplary method for uploading user-created media to a server for sharing with other users in accordance with embodiments of the disclosure;

FIG. 7 shows an exemplary method for retrieving shared content in accordance with embodiments of the disclosure;

FIG. 8 shows an exemplary method for sharing a user-created MSMP in accordance with embodiments of the disclosure;

FIG. 9 shows an exemplary method for retrieving shared MSMPs in accordance with embodiments of the disclosure;

FIG. 10 shows an exemplary method for compositing user-produced video assets into a single paned video for use in a MSMP in accordance with embodiments of the disclosure;

FIG. 11 shows an exemplary method for allowing user-produced content to be entered in contests in accordance with embodiments of the disclosure;

FIG. 12 shows an illustrative environment for managing the processes in accordance with embodiments of the disclosure; and

FIGS. 13 and 14 show description and exemplary depictions of aspects of embodiments of the disclosure.

### DETAILED DESCRIPTION OF EMBODIMENTS OF THE DISCLOSURE

In the following description, the various embodiments of the present disclosure will be described with respect to the enclosed drawings.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present invention in more detail than is necessary for the fundamental understanding of the present invention, the description is taken with the drawings making apparent to those skilled in the art how the forms of the present invention may be embodied in practice.

As used herein, the singular forms “a,” “an,” and “the” include the plural reference unless the context clearly dictates otherwise. For example, reference to “a magnetic material” would also mean that mixtures of one or more magnetic materials can be present unless specifically excluded.

Except where otherwise indicated, all numbers expressing physical quantities, such as frequency, time, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

The various embodiments disclosed herein can be used separately and in various combinations unless specifically stated to the contrary.

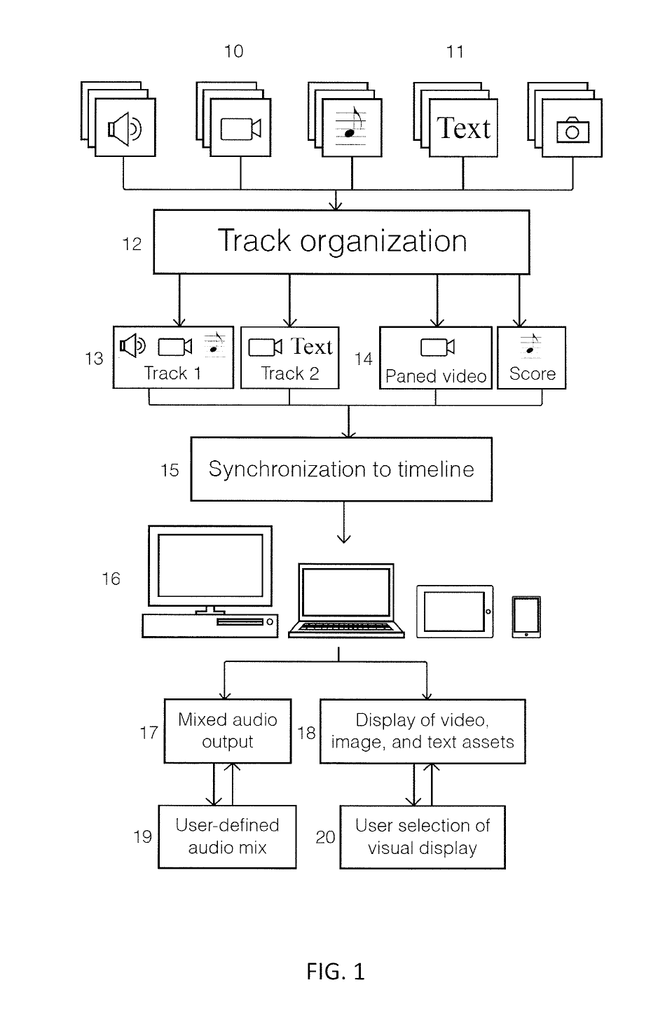

FIG. 1 shows an exemplary software environment for displaying multi-source media presentations (MSMPs) in accordance with embodiments of the disclosure. As shown in FIG. 1, the MSMP includes temporal, timeline-bound media 10 such as, for example, audio, video, music with scrolling cursors, and/or timed text. The exemplary MSMP also includes static, timeline-independent media 11, such as text and/or images, for example. In embodiments, each media asset may be organized into related tracks 12. This includes media that represents a single performer or event 13 that should be grouped together, such as, for example, corresponding audio, video, and sheet music for a single instrument in a band performance. There are also stand-alone assets that may not be grouped 14, such as, for example, a paned video of all instruments in a band performance, a sheet music score containing all played parts, commentary audio tracks, and/or teacher notes on a student's performance.

In accordance with aspects of the disclosure, once organized into tracks, the media is synchronized to a timeline 15. Once the media is synchronized, the media may be output through a variety of ways, including, e.g., by a hardware device such as a desktop computer, laptop, tablet, or smartphone 16. In embodiments, the output includes mixed audio output through speakers 17 that allows real-time user manipulation of the audio mix 18. The MSMP may also include a controllable display of video, images, or text 19. In accordance with aspects of embodiments of the disclosure, users can select which visual media assets are displayed 20.

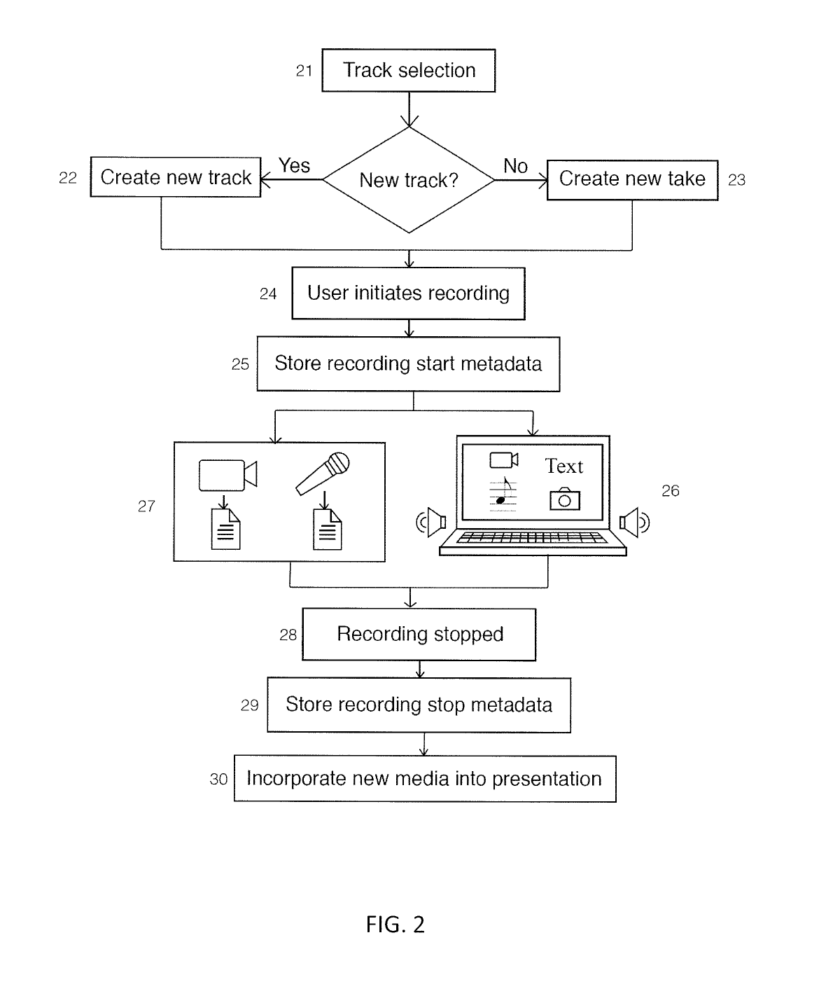

FIG. 2 shows an exemplary method of recording audio and video assets along with a synchronized MSMP. It includes user selection of a track 21, as described in FIG. 1, item 13. Either a new track is created 22, or a new take for an existing track is created 23. Upon user prompting, a recording is initiated 24. Metadata for the beginning of the recording, including start time of the current recording within the presentation timeline is stored 25. Two processes are run concurrently. Playback of the MSMP 26 is conducted as described in FIG. 1. Simultaneously, audio and video inputs are recorded into as separate media sources 27. Upon user prompting or at the end of the MSMP timeline, the recording is stopped 28, and the length of the newly recorded video and audio assets are saved 29. The newly recorded assets are then incorporated into the MSMP 30, and are ready for playback as described in FIG. 1.

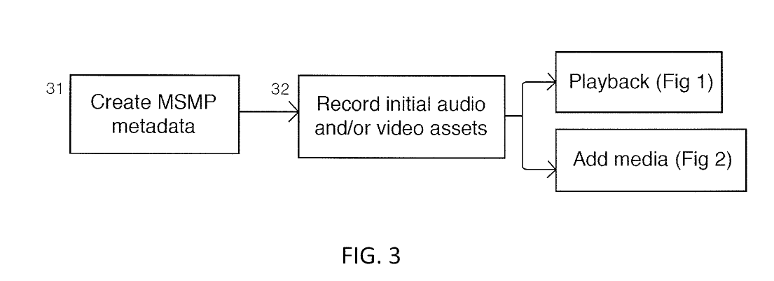

FIG. 3 shows an exemplary method of creating an MSMP in a piecemeal fashion, by adding one media asset at a time. Metadata for the MSMP is created 31, such as MSMP title, recording date, composer, performer name, and instrument listing, amongst other contemplated metadata. The user records an initial performance 32, and the initial performance is stored and treated as an MSMP with one track. This newly created MSMP is ready for playback as shown in FIG. 1 or for additional media recording as shown in FIG. 2.

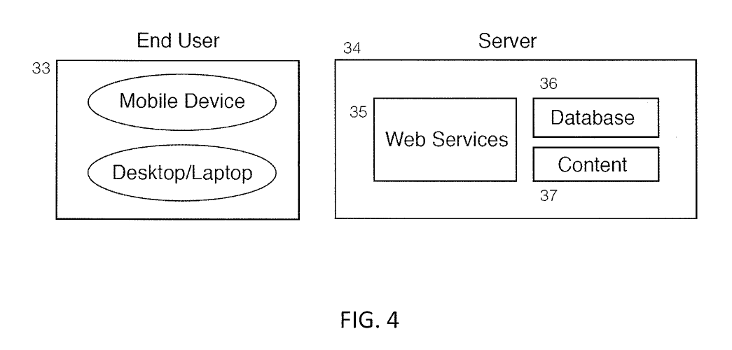

FIG. 4 shows an exemplary environment for remote storage of MSMP metadata and media content on a server in accordance with aspects of embodiments of the disclosure. The exemplary environment includes end users and devices that may be used to display MSMPs, including, for example, desktop computers, laptop computers, tablets, smartphones, and other mobile devices 33. As shown in FIG. 4, the exemplary environment also includes a server 34, with Web Services for communication between end users and server data 35, a database for organizing and storing MSMP metadata 36, and MSMP media content 37.

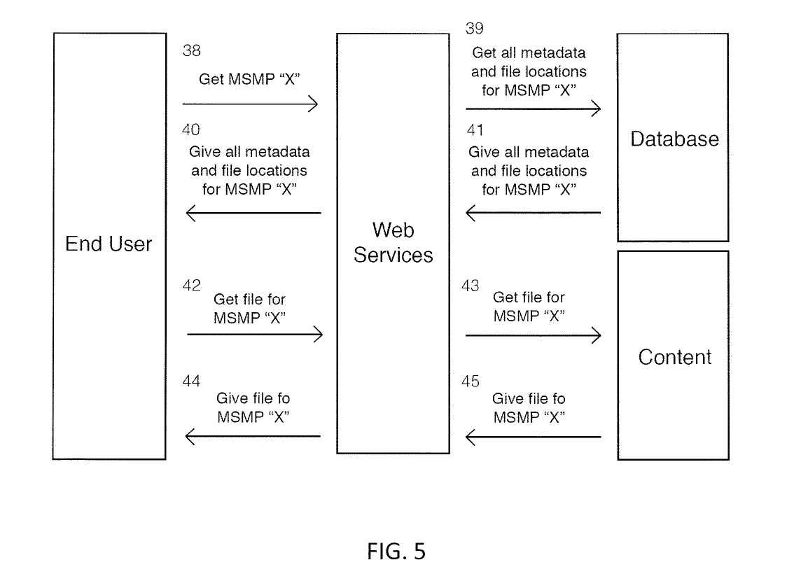

FIG. 5 shows an exemplary method for delivering MSMPs from a remote server to end users. The exemplary method includes an initial request from the user to receive a particular MSMP, in this example called MSMP “X” 38. The Web services are operable to send a request to the database for all metadata and file locations for MSMP “X” 39. The database returns all metadata and file locations for MSMP “X” 40. Web Services then delivers all metadata and file locations for MSMP “X” 41. For each file in the delivered list of file locations, the end user may request delivery of that file 42, then web services forwards the request to content storage 43. Content storage delivers the file 44, and Web Services forwards the delivery to the end user 45. Steps 42-45 may be repeated until all files in MSMP “X” are downloaded to local storage on the end user's device.

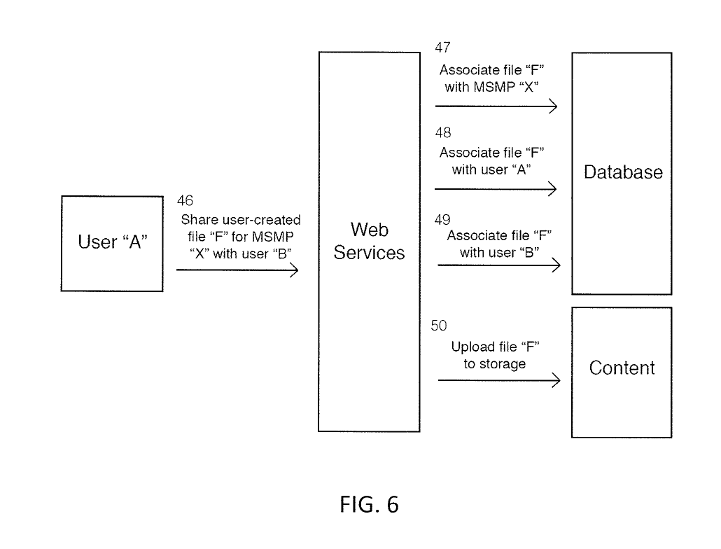

FIG. 6 shows an exemplary method for uploading user-created media to a server for the purpose of sharing with other users in accordance with aspects of embodiments of the disclosure. As shown in FIG. 6, User “A” adds media to a MSMP as described in FIG. 2. User “A” then makes a request to share the created media file “F” with another user, e.g., User “B” 46. Web Services add several pieces of data to the database, including data linking and associating file “F” with MSMP “X” 47, data linking and associating file “F” with user “A” 48, and data linking and associating file “F” with user “B” 49. Web Services also uploads file “F” to storage for User “B” to download 50.

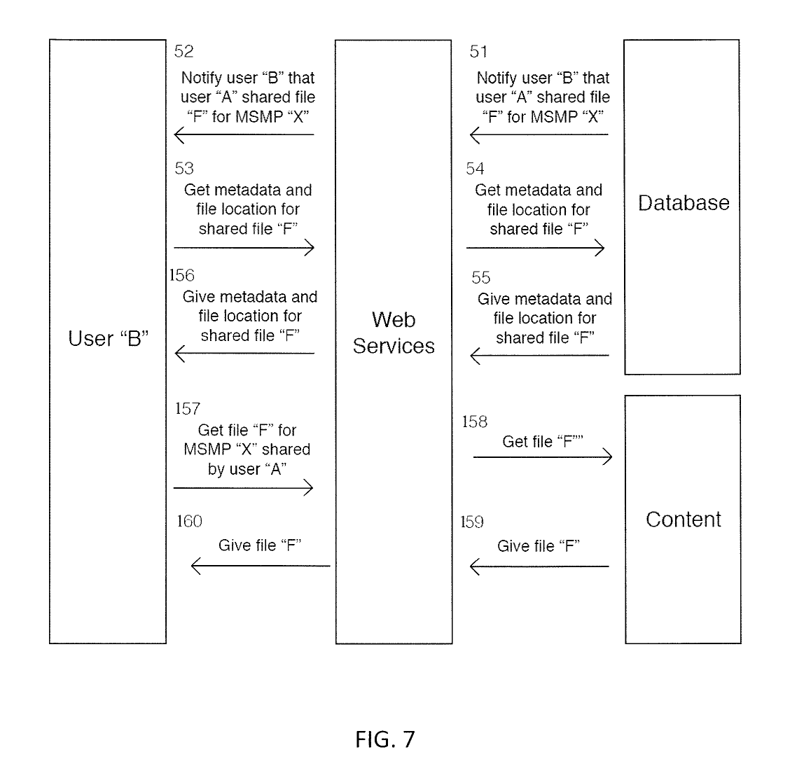

FIG. 7 shows an exemplary method for retrieving shared content in accordance with aspects of embodiments of the disclosure. After a user shares content, Web Services is operable to notify the end user that media has been shared. For example, user “A” shares file “F” for MSMP “X” with user “B,” and Web Services retrieves a notification from the database 51 and sends that notification to user “B” 52. When user “B” decides to receive the shared media, a request is put forth to Web Services for the file metadata and file location 53. Web Services passes the request to the database 54. The database gives the file metadata and file location to Web Services 55 which then passes the file metadata and file location to user “B” 156. A request is sent to Web Services for file “F” 157. Web Services passes the request to content storage 158. Content storage delivers the file 159, and it is passed to the end user 160. It is incorporated into MSMP “X” as described in FIG. 1.

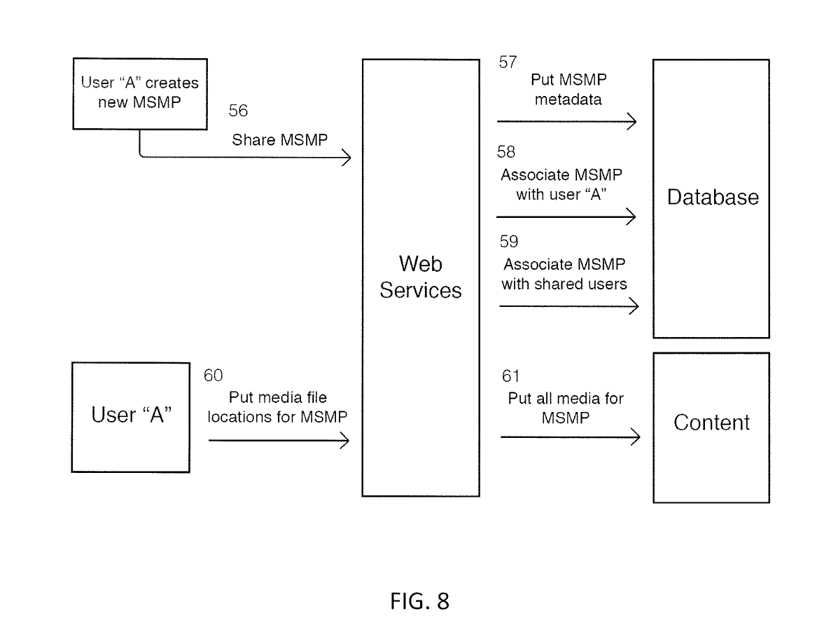

FIG. 8 shows an exemplary method for sharing a user-created MSMP. After a user creates a MSMP as described in FIG. 3, in embodiments of the disclosure, the MSMP can optionally be shared with other users. As shown in FIG. 8, user “A” requests to share the MSMP with other users 56. In embodiments, the MSMP may be shared with individually chosen users (e.g., private collaborators), or shared openly within a community of users (e.g., public collaborators). With this exemplary and non-limiting method, Web Services puts new database entries with the MSMP metadata 57 and associate the MSMP with its creator 58. Web services also associates the MSMP with all shared users 59. After database configuration, the file locations for MSMP media are given to web services 60 and uploaded into content storage 61.

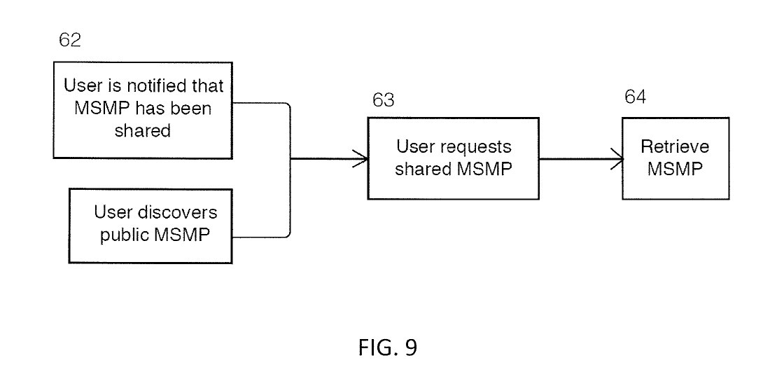

FIG. 9 shows an exemplary method for retrieving shared MSMPs. In embodiments, a user may, for example, be notified that another user has shared a new MSMP, or a user may discover a publicly shared MSMP 62. The user then requests the MSMP from the server 63. The server delivers the MSMP as described in FIG. 5. The user can now manipulate the MSMP, add content as described in FIG. 2, and share created content as described in FIG. 6.

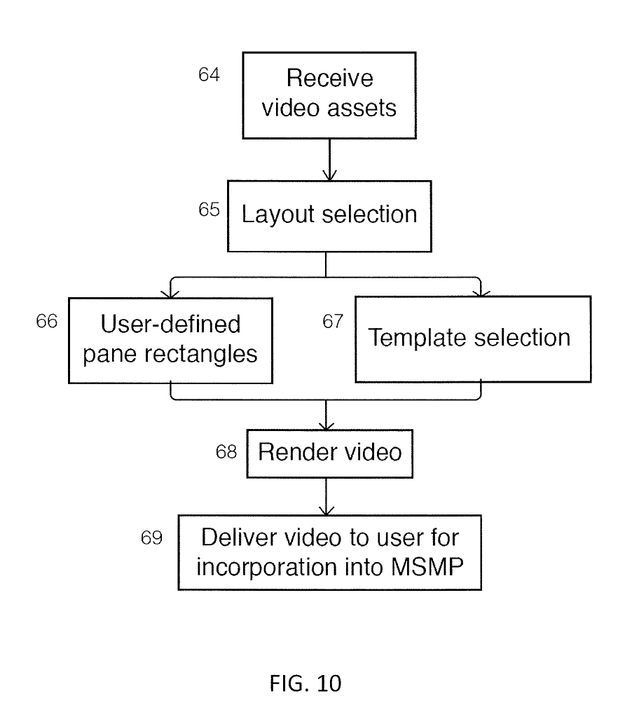

FIG. 10 shows an exemplary method for compositing user-produced video assets (which include audio) into a single paned video for use in a MSMP. Video assets are collected, either in local storage on the end user's device, or in server content storage 64. The user selects a layout 65 either by defining the visible pane rectangles themselves 66 or by selecting a layout from a template 67. The video assets are rendered into a single video 68. The paned video is then optionally delivered to the user if compositing is done remotely, and incorporated into the MSMP 69.

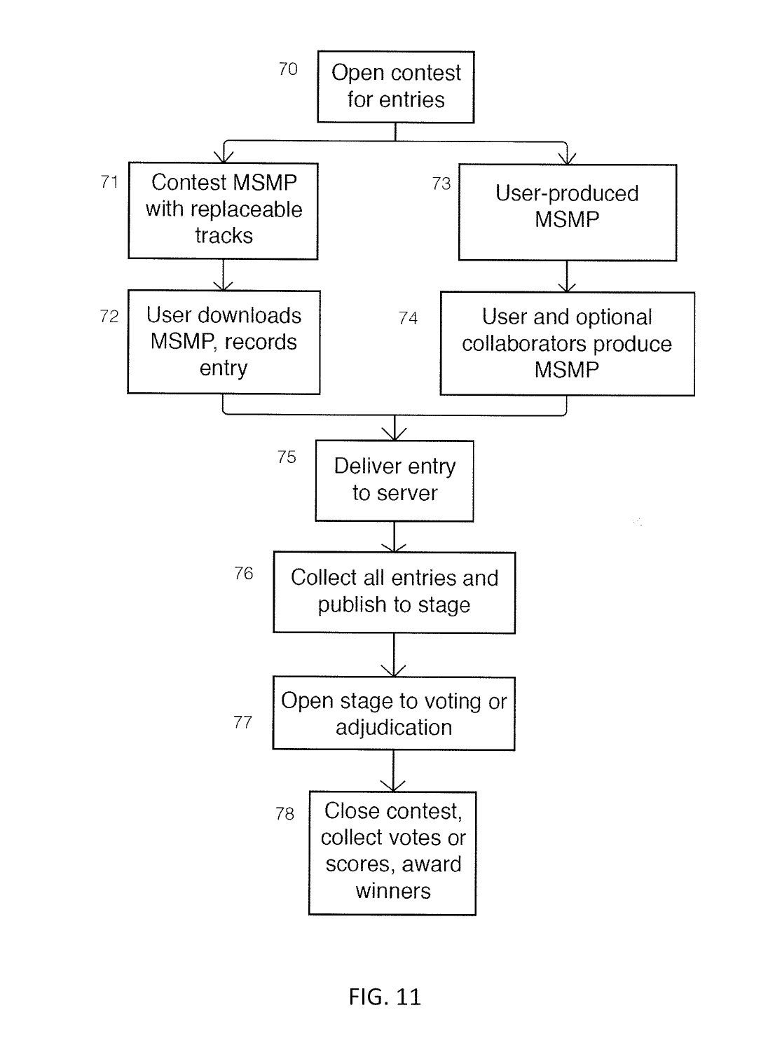

FIG. 11 shows an exemplary method for allowing user-produced content to be entered in contests in accordance with aspects of the disclosure. The contest is opened for entries 70. At least two types of contests may be utilized. For example, a contest may be a track replacement contest 71. With a track replacement contest, a MSMP is produced by the contest holder with the intention of user replacing one or more parts. For example, the contest may be a search for the best guitar solo to fit a song by a popular artist. The user downloads the MSMP as in FIG. 5, replaces content as in FIG. 2 for a contest entry 72. Another type of exemplary contest is a user-produced MSMP 73. For example, a contest could be a social media battle of the bands, or a songwriting contest. The contest entries may be produced from scratch 74 as shown in FIG. 3 either by single users or by a collaborative effort as shown in FIG. 8. In both contest cases, after the contest entry is created it is delivered to the server for storage 75 as described in FIG. 6. In embodiments, all entries may be collected and published to an online “stage” 76. In embodiments, the “stage” can, for example, be public and voted on by any user, or privately adjudicated, e.g., by a judging panel 77. After the contest is closed, public votes or adjudication scores, or a combination of both may be collected, e.g., using a computer processor and awards may be distributed to contest winners based on contest rules 78.

### System Environment

As will be appreciated by one skilled in the art, embodiments of the present invention may be embodied as a system, a method or a computer program product. Accordingly, embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following:
an electrical connection having one or more wires,
a portable computer diskette,
a hard disk,
a random access memory (RAM),
a read-only memory (ROM),
an erasable programmable read-only memory (EPROM or Flash memory),
an optical fiber,
a portable compact disc read-only memory (CDROM),
an optical storage device,
a transmission media such as those supporting the Internet or an intranet,
a magnetic storage device
a usb key,
a certificate, and/or
a mobile phone.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider). Additionally, in embodiments, the present invention may be embodied in a field programmable gate array (FPGA).

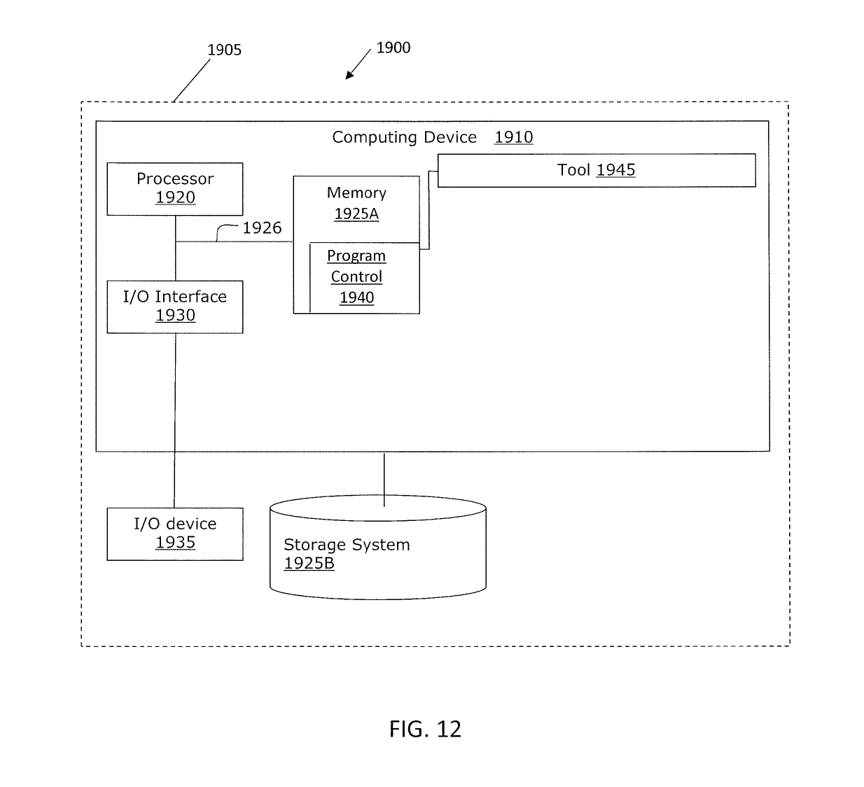

FIG. 12 shows an illustrative environment 1900 for managing the processes in accordance with the disclosure. To this extent, the environment 1900 includes a server or other computing system 1905 that can perform the processes described herein. In particular, the server 1905 includes a computing device 1910. The computing device 1910 can be resident on a network infrastructure or computing device of a third party service provider (any of which is generally represented in FIG. 12).

In embodiments, the computing device 1910 includes one or more tools 1945, which are operable to perform, e.g., the processes described herein. The one or more tools 1945 can be implemented as one or more program code in the program control 1940 stored in memory 1925A as separate or combined modules.

The computing device 1910 also includes a processor 1920, memory 1925A, an I/O interface 1930, and a bus 1926. The memory 1925A can include local memory employed during actual execution of program code, bulk storage, and cache memories which provide temporary storage of at least some program code in order to reduce the number of times code must be retrieved from bulk storage during execution. In addition, the computing device includes random access memory (RAM), a read-only memory (ROM), and an operating system (O/S).

The computing device 1910 is in communication with the external I/O device/resource 1935 and the storage system 1925B. For example, the I/O device 1935 can comprise any device that enables an individual to interact with the computing device 1910 or any device that enables the computing device 1910 to communicate with one or more other computing devices using any type of communications link. The external I/O device/resource 1935 may be, for example, a handheld device, PDA, handset, keyboard, smartphone, etc.

In general, the processor 1920 executes computer program code (e.g., program control 1940), which can be stored in the memory 1925A and/or storage system 1925B. Moreover, in accordance with aspects of the disclosure, the program control 1940 having program code controls the one or more tools 1945. While executing the computer program code, the processor 1920 can read and/or write data to/from memory 1925A, storage system 1925B, and/or I/O interface 1930. The program code executes the processes of the invention. The bus 1926 provides a communications link between each of the components in the computing device 1910.

The computing device 1910 can comprise any general purpose computing article of manufacture capable of executing computer program code installed thereon (e.g., a personal computer, server, etc.). However, it is understood that the computing device 1910 is only representative of various possible equivalent-computing devices that may perform the processes described herein. To this extent, in embodiments, the functionality provided by the computing device 1910 can be implemented by a computing article of manufacture that includes any combination of general and/or specific purpose hardware and/or computer program code. In each embodiment, the program code and hardware can be created using standard programming and engineering techniques, respectively.

Similarly, the computing infrastructure 1905 is only illustrative of various types of computer infrastructures for implementing the invention. For example, in embodiments, the server 1905 comprises two or more computing devices (e.g., a server cluster) that communicate over any type of communications link, such as a network, a shared memory, or the like, to perform the process described herein. Further, while performing the processes described herein, one or more computing devices on the server 1905 can communicate with one or more other computing devices external to the server 1905 using any type of communications link. The communications link can comprise any combination of wired and/or wireless links; any combination of one or more types of networks (e.g., the Internet, a wide area network, a local area network, a virtual private network, etc.); and/or utilize any combination of transmission techniques and protocols.

### Flow Diagram

FIGS. 1-3 and 5-11 shows exemplary flows for performing aspects of embodiments of the present disclosure. The steps of FIGS. 1-3 and 5-11 may be implemented in the environment of FIG. 12, for example. The flow diagrams may equally represent high-level block diagrams of embodiments of the disclosure. The flowcharts and/or block diagrams in FIGS. 1-3 and 5-11 illustrate the architecture, functionality, and operation of possible implementations of systems, methods and computer program products according to various embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. Each block of each flowchart, and combinations of the flowchart illustrations can be implemented by special purpose hardware-based systems that perform the specified functions or acts, or combinations of special purpose hardware and computer instructions and/or software, as described above. Moreover, the steps of the flow diagrams may be implemented and executed from either a server, in a client server relationship, or they may run on a user workstation with operative information conveyed to the user workstation. In an embodiment, the software elements include firmware, resident software, microcode, etc.

Furthermore, the invention can take the form of a computer program product accessible from a computer-usable or computer-readable medium providing program code for use by or in connection with a computer or any instruction execution system. The software and/or computer program product can be implemented in the environment of FIG. 12. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

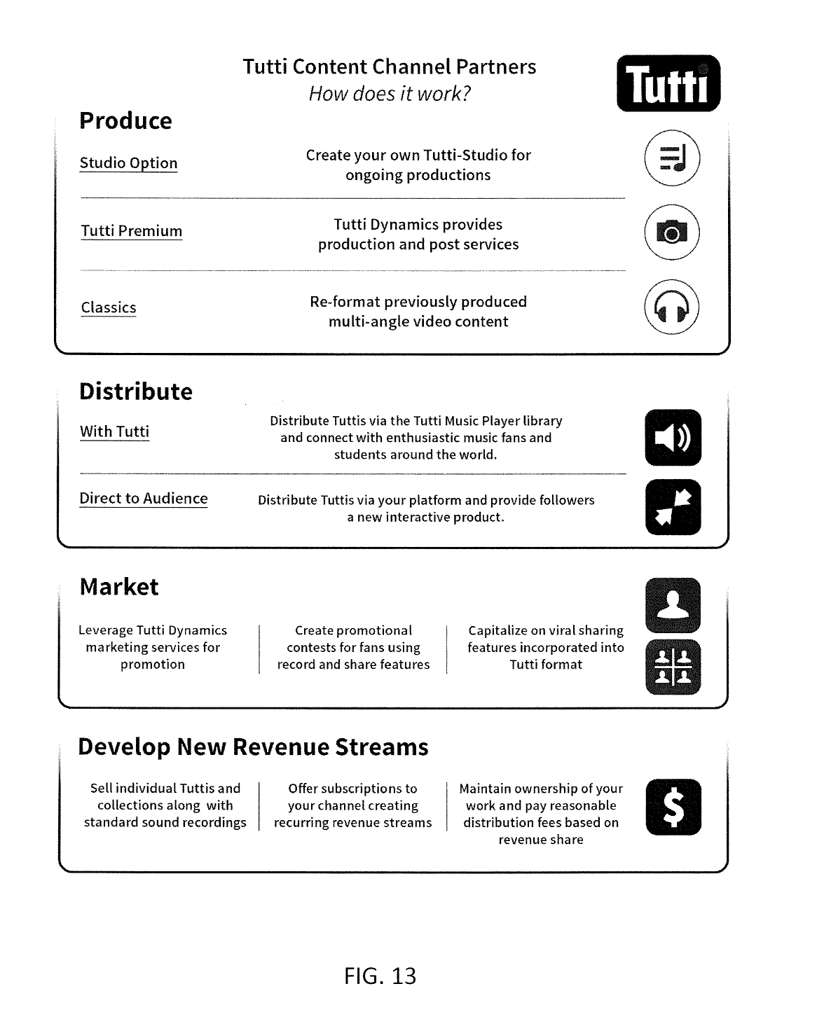

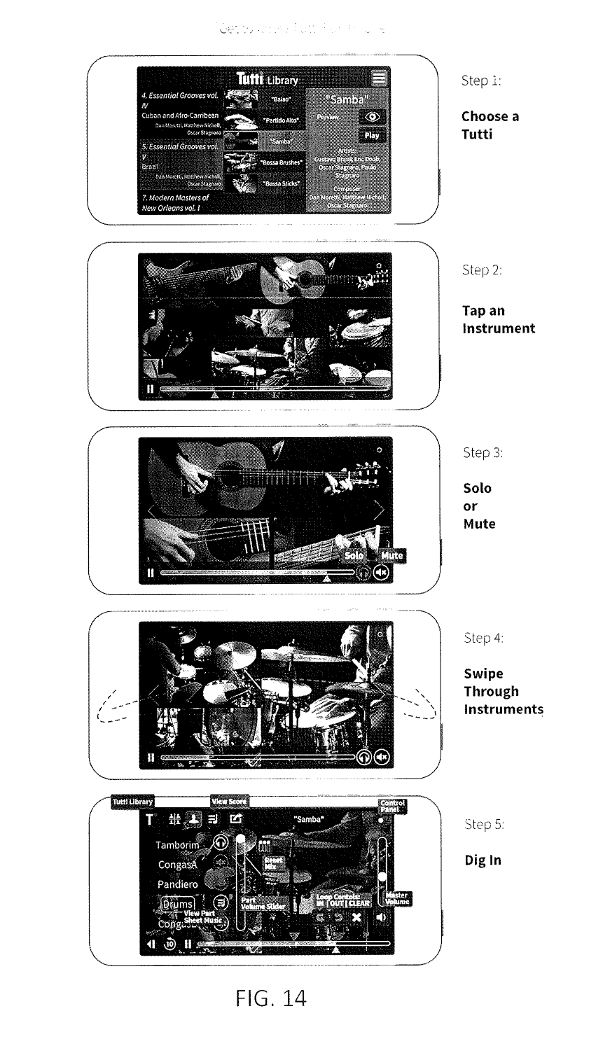

FIGS. 13 and 14 show description and exemplary depictions of aspects of embodiments of the disclosure. As shown in FIG. 14, a user may first choose a Tutti (e.g., a MSMP). Once the MSMP is downloaded to a user device, the MSMP may be played on the user device. That is, in embodiments, the MSMP provides, for example, views of the different instruments (and players) utilized in the particular musical composition. For example, the musical composition of the MSMP may include multiple instruments, e.g., a bass guitar, an acoustic guitar, percussion instruments, and drums. In accordance with aspects of the disclosure, the user may tap on an instrument displayed (e.g., the acoustic guitar) to provide a more detailed display of the selected instrument (e.g., different views of the instrument and player), for example, to display the musician's playing technique (e.g., strumming style, fingerings, etc.). In embodiments, aspects of the musical composition (e.g., a single instrument track) may be soloed (e.g., the instrument is played with all remaining instruments muted). In embodiments, aspects of the musical composition (e.g., a single instrument track) may be muted (e.g., the instrument is muted with all remaining instruments played). As illustrated in FIG. 14, a user may swipe the screen of the user device to scroll between different instruments of the MSMP (or Tutti). As shown in the exemplary depiction of FIG. 14, in embodiments, the graphical user interface may include a master volume control, a looping control, a part (e.g., single instrument) volume control, a reset mix actuator (e.g., button or selector), a view sheet music actuator, a view score actuator, a library actuator, and a control panel selector, amongst other contemplated controls and/or actuators.

While the invention has been described with reference to specific embodiments, those skilled in the art will understand that various changes may be made and equivalents may be substituted for elements thereof without departing from the true spirit and scope of the invention. For example, while the exemplary embodiments have been explained primarily in the context of musical instruction, the invention is not limited to such embodiments, and contemplates other fields, such as dance instruction, fitness instruction, medical instruction, corporate presentations, interactive advertisements, home security instruction, social networking presentations, or any other type of instruction or multi-media presentation. In addition, modifications may be made without departing from the essential teachings of the disclosure.

What is claimed is:

1. A method implemented in a computer infrastructure having computer executable code tangibly embodied on a computer readable medium, comprising:
recording at least one of audio, video, still image, text and other data representations; and
creating a multi-source media presentation, including the one or more of the audio, video, still image, text and other data representations.

2. The method of claim 1, further comprising replacing media in a multi-source presentation with user generated media.

3. The method of claim 1, further comprising adding media to a multi-source presentation.

4. The method of claim 1, further comprising delivering user generated media to a server for storage.

5. The method of claim 1, further comprising compositing user recorded video into a single composited “paned” video.

6. The method of claim 5, further comprising delivering the composited “paned” video to a user.

7. The method of claim 1, further comprising delivering user generated media to other users.

8. The method of claim 1, further comprising delivering a multi-source media presentation to users.

9. The method of claim 1, further comprising adding a user generated media file to the multi-source media presentation, including the at least one of audio, video, images, text, and other data.

10. The method of claim 1, further comprising:
recording a user generated video; and
replacing a single video in a multi-source presentation with the user generated video.

11. The method of claim 1, further comprising: recording of a new user generated audio file and replacement of a single audio file in a multi-source presentation with the user generated audio file.

12. The method of claim 1, wherein the multi-source media presentation comprises at least one of musical instruction, dance instruction, fitness instruction, medicine instruction, a corporate presentation, an interactive advertisement, home security presentation, or a social networking presentation.

13. The method of claim 1, further comprising delivering user-created media to a non-local server for storage.

14. The method of claim 1, further comprising generating a composite single paned video from multiple source videos.

15. The method of claim 1, further comprising delivering a composite video to a user.

16. The method of claim 1, further comprising delivering user-generated media to another user for the other user's entertainment or for additional creation.

17. The method of claim 16, further comprising the other user adding audio, video, still image, text, or other data representations to the multi-source media presentation.

18. The method of claim 16, further comprising the other user replacing existing audio, video, still image, text, or other data representations with their own media.

19. The method of claim 1, further comprising delivering a user-generated multi-source presentation to another user for the other user's entertainment or for additional creation.

20. The method of claim 19, further comprising the other user adding audio, video, still image, text, or other data representations to the multi-source media presentation.

21. The method of claim 19, further comprising the other user replacing existing audio, video, still image, text, or other data representations with their own media.

22. A system for creation and/or publication of collaborative multi-source media presentations, which is implemented in a computer infrastructure having computer executable code tangibly embodied on a computer readable medium, the system comprising:
a recording tool for recording at least one of audio, video, still image, text and other data representations; and
a creation tool configured for creating a multi-source media presentation, including the one or more of the audio, video, still image, text and other data representations.
